(19) United States
(12) Patent Application Publication
(10) Pub. No.: US 2011/0265907 A1
(43) Pub. Date: Nov. 3, 2011

(54) DEFORMING PRESS WITH A DEVICE FOR CONTROLLABLY SUPPLYING A METAL WIRE

(75) Inventors: Roberto TRABATTONI, Desio (IT); Paolo ROCCO, Lazzate (IT); Fabio ROCCATO, Rovellasca (IT)

(73) Assignee: SACMA Limbiate S.p.A., Limbiate (IT)

(21) Appl. No.: 13/088,566

(22) Filed: Apr. 18, 2011

(30) Foreign Application Priority Data
Apr. 29, 2010 (IT) MI2010A-000734

(51) Int. Cl. H01R 43/033

(52) U.S. Cl. 140/123

(57) ABSTRACT

A deforming press with a device for controllably supplying a metal wire includes a bottom guide disc and a top guide disc for the metal wire to be supplied, the discs having a circumferential slot, wherein the device further comprises wire supplying tubular guides, the bottom and top discs are supported by gear wheel driven supporting bottom and top shafts, the bottom shaft being operatively coupled to a controllable driving motor and each top disc being supported by a slide which may slide with respect to a body of the device, the slide being upward and downward driven by a driving cylinder-piston unit.

### BACKGROUND OF THE INVENTION

The present invention relates to a deforming press with device for controllably supplying a metal wire.

Deforming presses to which a workpiece, cut from a metal wire, is delivered from a metal wire coil are already known in the prior art.

In such a prior deforming press, single metal wire pieces, cut from the wound wire coil, are deformed in different processing operations, so as to provide a finished shaped workpiece.

To supply the deforming press with a desired length metal wire, prior deforming presses comprise lever, connecting rod, plug-in and brake mechanisms to precisely feed the cut wire piece to the press.

Thus, the provision of a lot of mechanical elements, operatively driven by the prior press main driveshaft, increases the driving device weight while causing difficulties for micrometrically adjusting the operating strokes of the press metal wire feeding mechanism.

Moreover, the provision of connecting rods, levers, plug-in and brake elements also increases the apparatus overall weight.

### SUMMARY OF THE INVENTION

Accordingly, the aim of the present invention is to overcome the above mentioned prior art drawbacks, by eliminating the above very complex mechanisms including connecting rods, levers, plug-in and brake elements, to provide a novel constructional very simple apparatus suitable to perform an easy micrometric adjustment of the wire being fed to the deforming press.

The above aim is achieved by a deforming press with a device for controllably supplying a metal wire, including a bottom guide disc and a top guide disc for the metal wire to be supplied, said discs having a circumferential slot, characterized in that said device comprises wire supplying tubular guides, that said bottom and top discs are supported by gear wheel driven supporting bottom and top shafts, that said bottom shaft is operatively coupled to a controllable driving motor and that each said top disc is supported by a slide which may slide with respect to a body of said device and that said slide may be upward and downward driven by a driving cylinder-piston unit.

Further advantages of the invention will become more apparent from the following disclosure, dependent claims and accompanying drawings.

### BRIEF DESCRIPTION OF THE DRAWINGS

The subject matter according to the present invention will be disclosed in a more detailed manner hereinafter with reference to the schematic accompanying drawings, where:

FIG. 1 is a front view of a feeding device for feeding a metal wire to a deforming press;

FIG. 2 is a cross-sectional view taken along the arrows II-II showing the device of FIG. 1; and

FIG. 3 is a further elevation view showing the rear side of the subject device.

### DESCRIPTION OF THE PREFERRED EMBODIMENT

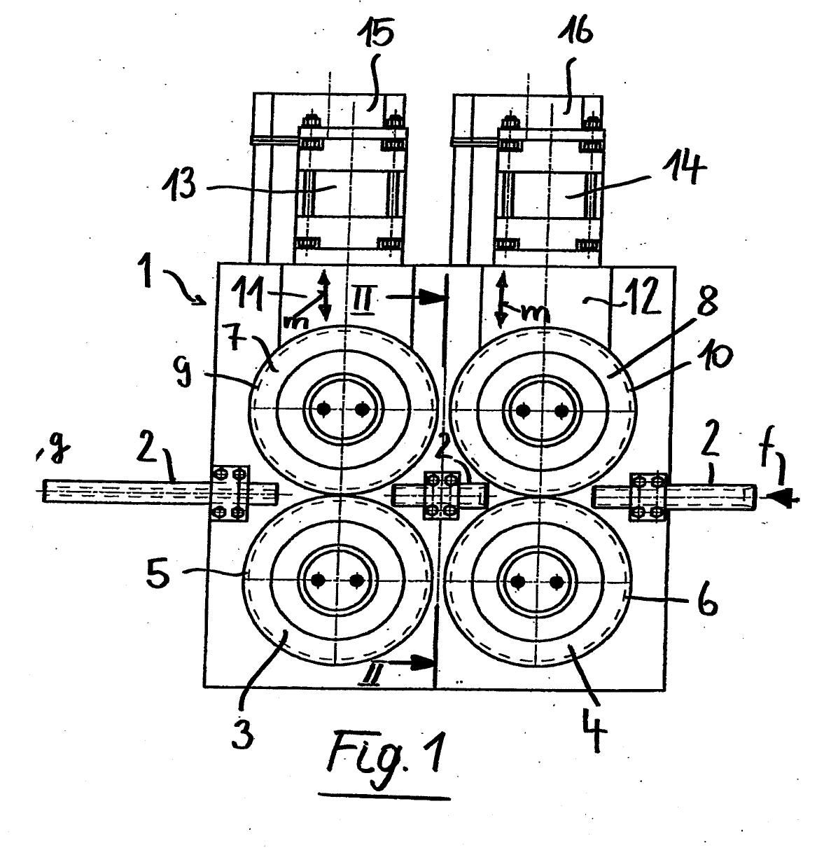

As shown in FIG. 1, the wire feeding or supplying device, which has been generally indicated by the reference number 1, comprises, arranged adjoining respective discs 3, 4, 7, 8, a plurality of interexchangeable tubular guides 2.

Through the tubular guides 2, the wire being driven in the direction of the arrow (f) exits said tubular guides 2, as indicated by the arrow (g) and is conveyed to a deforming press (not shown).

At the bottom portion of the device 1, guide discs 3 and 4 are provided.

Each said disc 3 and 4 is interexchangeable and comprises a circumferential slot 5 and 6, the radius of which depends on the diameter of the metal wire (not shown) to be conveyed or fed.

Above said guide discs 3 and 4 driving interexchangeable discs 7 and 8 are arranged.

Said discs 7 and 8 also comprise slots 9 and 10 the size of which is fitted to the diameter of the wire to be supplied through the tubular guides 2.

Advantageously, the top discs 7 and 8 are supported by guides or slides 11 and 12 and may be controllably driven, as schematically indicated by the double arrows (m), by driving cylinder-piston units 13 and 14.

Advantageously, said driving cylinder-piston units 13 and 14 are designed as controllable pneumatic hydraulic devices.

Thus, it is possible to control the pressure applied by the discs 8 and 9 on the wire F being fed.

The discs 7 and 8 are rotatively driven by controllable driving motors 15 and 16.

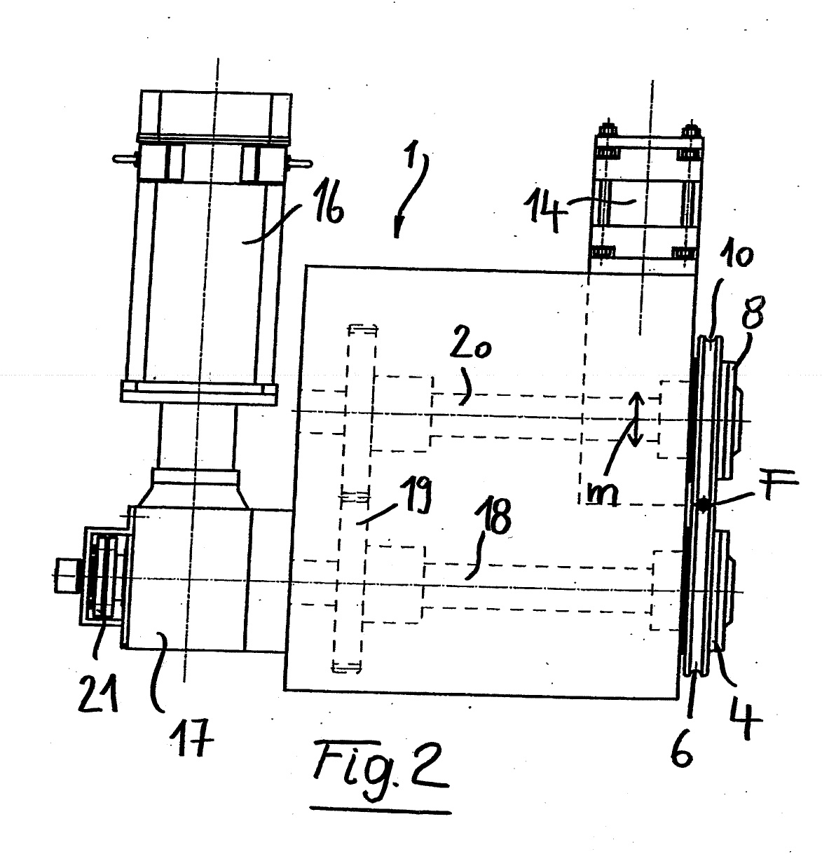

FIG. 2 is a side elevation view of the device 1, taken according to the arrows II-II of FIG. 1, and shows a top disc 8, which may be controllably driven in the direction of the arrow (m) and a wire F engaged in a slot 10 respectively a slot 6 of the top disc 8 and bottom disc 4.

FIG. 2 further shows the driving motor 16 driving, through a transmission assembly 17, the driveshaft 18 driving in turn the disc 4 and, through a gear wheel 19, the shaft 20 rotatively driving the top disc 8.

The transmission assembly 17 advantageously comprises a keying joint 21 making said transmission assembly 17 rigid with the corresponding shaft 18.

Thus, by the cylinder-piston unit 14 of FIG. 2, the disc 8 may be raised or lowered, which movement could also be achieved by using the cylinder-piston unit 13 operating the disc 7.

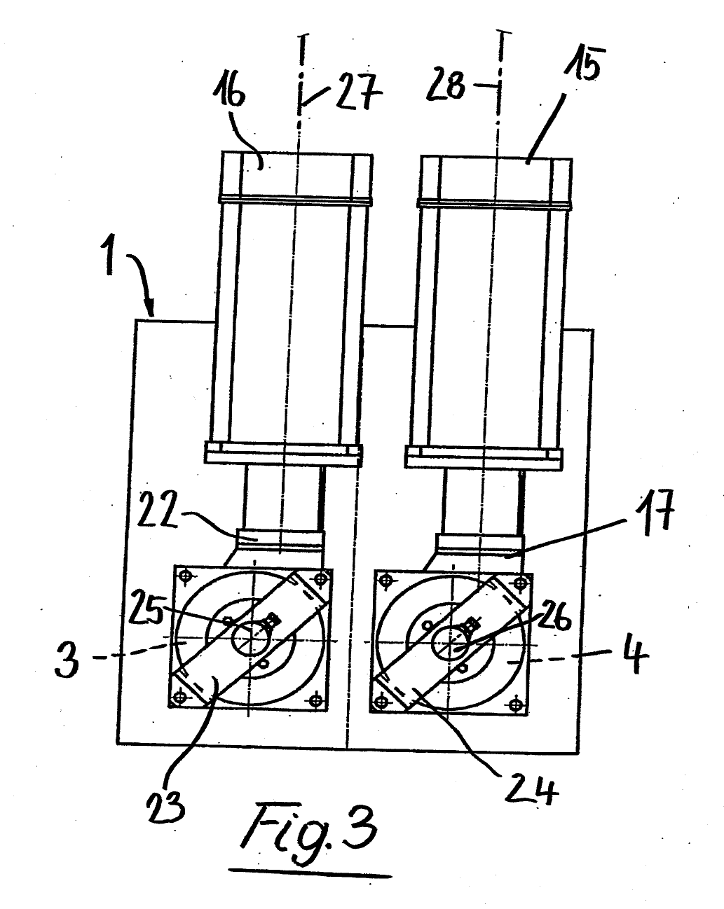

FIG. 3 shows the device 1 with the transmission assemblies 17 and 22 designed for rotatively driving the operating discs, also herein schematically indicated by the reference numbers 3 and 4.

At each transmission assemblies 17 and 22 supporting brackets 23 and 24 are arranged in turn supporting detecting and signaling means 25 and 26, for example encoder means, for calculating, through the machine numeric control system, the revolution number of the discs 3 and 4 and accordingly the feeding length of the metal wire F to the press (not shown).

In this connection it should be pointed out that the encodes 25 and 26 could also be omitted; while precisely controlling the bottom disc 3 and 4 movement directly through the motors 15 and 16 which advantageously comprise controllable motors including conventional control and driving means, schematically indicated by 28 in FIG. 2 and being coupled to the press numeric control system.

Thus, by the above disclosed means, it is possible to supply a wire, delivered from a wire coil, to a deforming press while defining with a maximum precision the wire F feeding time and path and the length of the cut wire to be conveyed to the deforming press.

It should be moreover pointed out that said electric motors are so designed as to allow the rotary direction thereof to be reversed, to also reverse the movement of the discs, for allowing the wire to be controllably fed to the deforming press, and also withdrawn therefrom.

On the contrary, in prior deforming presses, the above mentioned wire reciprocating required an independent device arranged upstream of the wire F driving device 1.

Thus, the invention allows to omit all the above mentioned wire feeding devices including connecting rods, levers, plug-in and brake elements, and supplies the metal wire to the deforming press by a device requiring a small maintenance, and including cylinder-piston units 13 and 14 and controllable motors 15 and 16 which may be easily controlled and which, in a failure event, may be very quickly and easily replaced.

1. A deforming press with a device (1) for controllably supplying a metal wire (F), including a bottom guide disc (3, 4) and a top guide disc (7, 8) for the metal wire (F) to be supplied, said discs (3, 4, 7, 8) having a circumferential slot (5, 6, 9, 10), characterized in that said device comprises wire (F) supplying tubular guides (2), that said bottom (3, 4) and top (7, 8) discs are supported by gear wheel (19) driven supporting bottom (18) and top (20) shafts, that said bottom shaft (18) is operatively coupled to a controllable driving motor (15, 16) and that each said top disc (7, 8) is supported by a slide (11, 12) which may slide with respect to a body of said device (1) and that said slide (11, 12) may be upward and downward driven by a driving cylinder-piston unit (13, 14).

2. A deforming press with a device for controllably supplying a metal wire, according to claim 1, characterized in that said press comprises a plurality of interexchangeable wire (F) guides (2).

3. A deforming press with a device for controllably supplying a metal wire, according to claim 1, characterized in that each said disc (3, 4, 7, 8) is an interexchangeable disc and has a circumferential slot (5, 6, 9, 10) having a radius depending on a diameter of said metal wire (F) to be supplied.

4. A deforming press with a device for controllably supplying a metal wire, according to claim 1, characterized in that said top discs (7, 8) are supported by supporting guides (11, 12) and are controllably movably driven by a driving cylinder-piston unit (13, 14) in the form of a controllable hydraulic-pneumatic device.

5. A deforming press with a device for controllably supplying a metal wire, according to claim 1, characterized in that said bottom discs (3, 4) are rotatively driven by controllable driving motors (15, 16).

6. A deforming press with a device for controllably supplying a metal wire, according to claim 1, characterized in that each driving motor (15, 16) is operatively coupled to a respective transmission assembly (17, 22) each coupled to the shaft (18) actuating the corresponding disc (3, 4) and that said shaft (18) supports said gearwheel (19) for driving said top disc (7, 8) supporting top shaft (20).

7. A deforming press with a device for controllably supplying a metal wire, according to claim 1, characterized in that said cylinder-piston unit (13, 14) is operatively coupled to a control system of said device (1) for either raising or lowering said top disc (7, 8).

8. A deforming press with a device for controllably supplying a metal wire, according to claim 1, characterized in that at each said disc (3, 4, 7, 8) rotatively driving transmission assembly (17, 22) are arranged supporting brackets (23, 24) supporting detecting (25, 26) and signaling means, such as encoder means.

9. A deforming press with a device for controllably supplying a metal wire, according to claim 1, characterized in that said bottom discs (3, 4) are directly driven by controllable driving motors (15, 16).

10. A deforming press with a device for controllably supplying a metal wire, according to claim 1, characterized in that said wire (F) supplying disc (3, 4, 7, 8) driving motors (15, 16) comprise reversible electric motors.
